(19) United States
(12) Patent Application Publication
(10) Pub. No.: US 2016/0230484 A1
(43) Pub. Date: Aug. 11, 2016

(54) WELLBORE HYDRAULIC COMPLIANCE

(71) Applicant: SCHLUMBERGER TECHNOLOGY CORPORATION, Sugar Land,, TX (US)

(72) Inventors: Ashley Bernard Johnson, Cambridge (UK); Devi Putra, Cambridge (UK); Maurice Ringer, Roissy-en-France (FR); Benjamin Peter Jeffryes, Cambridgeshire (UK)

(21) Appl. No.: 15/023,116

(22) PCT Filed: Sep. 19, 2014
(86) PCT No.: PCT/US14/56560

§ 371 Date: Mar. 18, 2016

Related U.S. Application Data
(60) Provisional application No. 61/880,074, filed on Sep. 19, 2013.

(51) Int. Cl. E21B 21/08; G05B 15/02; G05D 7/06; E21B 47/10; E21B 47/06

(52) U.S. Cl. CPC E21B 21/08; E21B 47/10; E21B 47/06; G05D 7/0676; G05B 15/02

(57) ABSTRACT

A method for determining hydraulic compliance of a wellbore during a managed pressure drilling procedure. Measurements are made of the pressure of a drilling fluid being circulated in the wellbore during the procedure at the top of a drilling annulus, the flow rate qᵢₙ of the drilling fluid into the wellbore and the flow rate qₒᵤₜ of the fluid out of the wellbore. These three measurements are used to determine the difference of the flow rates and a discrete time derivative (Pₜ−P_{t-Δt})/Δt of the pressure, where t is time and Δt is a time interval. The differences in flow rates and the time derivatives are then processed by applying a low pass filter to determine the hydraulic compliance of the wellbore.

### BACKGROUND

The present invention relates to determination of a hydraulic compliance of a wellbore.

In the hydrocarbon industry, wellbores are drilled into subterranean hydrocarbon reservoirs so that the hydrocarbons can be recovered. The drilling of a wellbore is typically carried out using a tubular steel pipe known as a drillstring with a drill bit on the lowermost end; the drill bit is normally attached to or is a part of a bottomhole assembly attached to the lower end of the drillstring. In a drilling procedure, the entire drillstring may be rotated using an over-ground drilling motor, or the drill bit may be rotated independently of the drillstring using a fluid powered motor or motors mounted in the drillstring just above the drill bit. As drilling progresses, a flow of drilling fluid is used to carry the debris created by the drilling process out of the wellbore. During the drilling procedure, the drilling fluid is pumped through an inlet line down the drillstring, passes through in the drill bit, and returns to the surface via an annular space between the outer diameter of the drillstring and the wellbore (the annular space is generally referred to as the annulus).

Drilling fluid is a broad drilling term that may cover various different types of drilling fluids. The term “drilling fluid” may be used to describe any fluid or fluid mixture used during drilling and may cover such things as drilling mud, heavily weighted mixtures of oil or water with solid particles, air, nitrogen, misted fluids in air or nitrogen, foamed fluids with air or nitrogen, aerated or nitrified fluids.

In practice, the flow of drilling fluid through the drillstring may be used to cool the drill bit as well as to remove the cuttings from the bottom of the wellbore. In conventional overbalanced drilling, the density of the drilling fluid is selected so that it produces a pressure at the bottom of the wellbore (the “bottom hole pressure” or “BHP”), which is high enough to counter-balance the pressure of fluids in the formation (“the formation pore pressure”). By counter-balancing the pore pressure, the BHP acts to prevent the inflow of fluids from the formations surrounding the wellbore into the wellbore.

However, if the BHP falls below the formation pore pressure, formation fluids, such as gas, oil and/or water may enter the wellbore and produce what is known in drilling as a kick. By contrast, if the BHP is high, the BHP may be higher than the fracture strength of the formation surrounding the wellbore resulting in fracturing of the formation. When the formation is fractured, the drilling fluid may enter the formation and be lost from the drilling process. This loss of drilling fluid from the drilling process may cause a reduction in BHP and as a consequence cause a kick as the BHP falls below the formation pore pressure. Loss of fluid to the formations as a result of fracturing is known as fluid loss or lost circulation and may be expensive, as a result of the lost drilling fluid, and an increase in the time to drill the wellbore. Kicks are also dangerous and the liquid and/or gas surge associated with the influx into the wellbore requires handling at surface.

In order to overcome the problems of kicks and/or fracturing of the formation during drilling, a process known as managed pressure drilling (“MPD”) has been developed. In managed pressure drilling various techniques are used to control/manage the BHP during the drilling process. In MPD, the flow of drilling fluid into and out of the wellbore is controlled. This means that pumps that pump the fluid into the wellbore and chokes that control the flow of fluid out of the wellbore are controlled to control the BHP. Additionally, gas may be injected into the drilling fluid to reduce the drilling fluid density and thus reduce the BHP produced by the column of the drilling fluid in the drilling annulus. In general, until recently, MPD techniques have been fairly crude relying on manual control of the pumps and choke.

In MPD, the annulus may be closed or “shut-in” using a pressure containment device. This device comprises sealing elements, which engage with the outside surface of the drillstring so that flow of fluid between the sealing elements and the drillstring is substantially prevented. The sealing elements may allow for rotation of the drillstring in the wellbore so that the drill bit on the lower end of the drillstring may be rotated. A flow control device may be used to provide a flow path for the escape of drilling fluid from the annulus. After the flow control device, a pressure control manifold with at least one adjustable choke or valve may be used to control the rate of flow of drilling fluid out of the annulus. When partially closed during drilling, the pressure containment device creates a backpressure in the wellbore, and this back pressure can be controlled by using the adjustable choke or valve on the pressure control manifold to control the degree to which flow of drilling fluid out of the annulus is restricted.

During MPD an operator may monitor and compare the flow rate of drilling fluid into the drillstring with the flow rate of drilling fluid out of the annulus to detect if there has been a kick or if drilling fluid is being lost to the formation. A sudden increase in the volume or volume flow rate out of the annulus relative to the volume or volume flow rate into the drillstring may indicate that there has been a kick. By contrast, a sudden drop in the flow rate out of the annulus relative to the flow rate into the drillstring may indicate that the drilling fluid has penetrated the formation.

For improved control of MPD (or indeed other operations where fluid is pumped around a shut-in wellbore, such as cementing) it is desirable to be able to calculate or model the BHP or the pressure at other points in/along the wellbore tubing or annulus. Knowledge of the pressure distribution allows appropriate action to be taken, such as varying the pumping rate and/or rate of flow out of the annulus, to maintain or attain a desired pressure.

The governing model for a hydraulic control volume can be defined as:

$$\frac{d P}{d t} = \frac{1}{k} ( {q}_{in} - {q}_{out} ) \qquad ( 1 )$$

where P is pressure, t is time, qᵢₙ is the flow rate into the volume, qₒᵤₜ is the flow rate out of the volume, and k is the system compliance.

For a well in a typical MPD operation this can be written as:

$$\frac{d P}{d t} = \frac{1}{k} ( {q}_{pump} - {q}_{choke} + {q}_{influx} - {q}_{loss} ) \qquad ( 2 )$$

where qₚᵤₘₚ is the flow rate into the system at the pump, q_{choke} is the flow rate out of the system at the choke, q_{influx} is the flow rate into the system due to an event is such as a kick, and qₗₒₛₛ is the flow rate out of the system due leakage into a formation, and k can be further defined as:

k=ΣXₘᵢVₘᵢ+ΣX_{wi}V_{wi} (3)

where Xₘᵢ and Vₘᵢ are the fluid (e.g. mud) compressibility and volume respectively (for a single phase system there will be just a single term here, but for a multi-phase system or when a kick has occurred and there is a second fluid in the well there will be multiple terms in this summation), and X_{wi} and V_{wi} are the wellbore elasticity and volume for each section of the well. System compliance is discussed further in A. Johnson, I. Rezmer-Cooper, T. Bailey and D. McGann, Gas Migration: Fast, Slow or Stopped, SPE/IADC 29342.

Topside parameters such as qₚᵤₘₚ, q_{choke} and the fluid backpressure at the choke can generally be measured, but accurate process control or kick and loss detection may also requires knowledge of the system compliance, k. In a wellbore, open-hole elasticity is generally significantly higher than casing elasticity (where the wellbore is lined with a casing string), and is typically of similar order to the mud compressibility. So approximating the system compliance as a multiple of the mud compressibility is often inappropriate as the well becomes deeper and the relative length of the open hole increases. Further, determination of k can be problematic in practice, with large changes in system pressure being produced by small changes in fluid volume, and the fluid is generally being pumped at high flow rates making measurement of these small changes susceptible to measurement noise.

### SUMMARY

One embodiment of the present application provides for determination of wellbore compliance using appropriately filtered measurements of flow rate.

Accordingly, in one aspect, a method is provided for determining a hydraulic compliance of a wellbore during an operation to pump fluid onto a flow path which extends downhole through tubing located in the wellbore and then returns in the opposite direction through an annulus surrounding the tubing to a topside end of the annulus, the method comprising measuring the pressure P of the fluid at the topside end of the annulus; measuring the flow rate qᵢₙ of the fluid into the flow path; measuring the flow rate qₒᵤₜ of the fluid out of the flow path; determining a difference (qᵢₙ−qₒᵤₜ) of the flow rates; determining a discrete time derivative (Pₜ−P_{t-Δt})/Δt of the pressure, where t is time and Δt is a time interval; processing the difference of the flow rates and the discrete time derivative of the pressure by applying a low pass filter; and determining a hydraulic compliance of the wellbore as a gradient of a straight line fitted to values of the processed difference of the flow rates plotted against values of the processed discrete time derivative of the pressure.

Embodiments of the present disclosure provide, among other things, for determination of the hydraulic compliance “on-the-fly”, even at high flow rates.

In some embodiments, a method is provided for controlling a pumped flow rate and pressure of a fluid in a wellbore during an operation to pump the fluid into a flow path which extends downhole through tubing located in the wellbore and then returns in the opposite direction through an annulus surrounding the tubing to a topside end of the annulus, the pressure of the fluid being controllable at the topside end of the annulus (for example by a seal and choke arrangement), the method comprising: determining a set pressure (such as the bottom hole pressure) for the fluid at a position on the flow path; determining a set extraction rate of the fluid at the topside end of the annulus; performing a method to determine the hydraulic compliance of the wellbore, as described herein; and controlling the pressure of the fluid at the topside end of the annulus and controlling the pumped flow rate of the fluid onto the flow path in dependence on the hydraulic compliance to achieve the set pressure and extraction rate.

In other aspects, a method of detecting abnormal behaviour of a wellbore (such as influx of fluid into the wellbore, e.g. caused by a kick, or efflux of fluid out of the wellbore, e.g. caused by pumped fluid penetration into the formation) during an operation to pump fluid onto a flow path (which extends downhole through tubing located in the wellbore and then returns in the opposite direction through an annulus surrounding the tubing to a topside end of the annulus) is provided, where the method comprises: performing a method to determine the hydraulic compliance of the wellbore as described herein; and detecting abnormal behaviour on the basis of changes in the hydraulic compliance and/or in the constant term of the fitted straight line.

Further aspects provide a computer program comprising code which, when run on a computer, causes the computer to perform any of the methods described herein, a computer readable medium storing a non-transient computer program comprising code which, when run on a computer, causes the computer to perform any of the methods described herein; and a computer system programmed to perform the any of the methods described herein.

For example, a computer system may be used in a system for determining a hydraulic compliance of a wellbore during an operation to pump fluid onto a flow path which extends downhole through tubing located in the wellbore and then returns in the opposite direction through an annulus surrounding the tubing to a topside end of the annulus, the system including: a measurement receiving unit for (i) receiving measurements of the pressure P of the fluid at the topside end of the annulus, (ii) receiving measurements of the flow rate qᵢₙ of the fluid into at least a portion of the flow path, and (iii) receiving measurements of the flow rate qₒᵤₜ of the fluid out of said portion of the flow path; a processor unit for: (i) determining the difference (qᵢₙ−qₒᵤₜ) of the flow rates; (ii) determining the discrete time derivative (Pₜ−P_{t-Δt})/Δt of the pressure, where t is time and Δt is a time interval; (iii) processing the difference of the flow rates and the discrete time derivative of the pressure by applying a low pass filter to at least one of the difference of the flow rates and the discrete time derivative of the pressure; and (iv) determining a hydraulic compliance of the wellbore for said portion of the flow path as the gradient of a straight line fitted to values of the processed difference of the flow rates plotted against values of the processed discrete time derivative of the pressure.

Further, a computer system may be programmed to operate a controller for controlling the pumped flow rate and the pressure of fluid in a wellbore during an operation to pump the fluid onto a flow path which extends downhole through tubing located in the wellbore and then returns in the opposite direction through an annulus surrounding the tubing to a topside end of the annulus, the pressure of the fluid being controllable at the topside end of the annulus, the controller comprising:
a setting unit for setting (i) a pressure for the fluid at a position on the flow path, and (ii) an extraction rate of the fluid at the topside end of the annulus;
the previously-mentioned hydraulic compliance determining system; and
a control unit for controlling the pressure of the fluid at the topside end of the annulus and controlling the pumped flow rate of the fluid onto the flow path in dependence on the hydraulic compliance to achieve the set pressure and extraction rate.

Further, a computer system may be programmed to work with/operate a detector for detecting abnormal behaviour of a wellbore during an operation to pump fluid onto a flow path which extends downhole through tubing located in the wellbore and then returns in the opposite direction through an annulus surrounding the tubing to a topside end of the annulus, the detector including:
the previously-mentioned hydraulic compliance determining system; and
a detector unit for detecting abnormal behaviour on the basis of changes in the hydraulic compliance and/or in the constant term of the fitted straight line

Additional features of a wellbore compliance system or method are now set out. These features are applicable singly or in any combination with any aspect of a wellbore compliance system or method.

In some embodiments, the straight line is fitted directly to the values of the processed difference of the flow rates plotted against values of the processed discrete time derivative of the pressure. However, the fitting may be performed indirectly, e.g. by fitting a curve such as a quadratic (or other polynomial) to the values, and then taking the hydraulic compliance as the linear component of that curve.

A low pass filter may be applied to only the difference of the flow rates or to only the discrete time derivative of the pressure. However, in some aspects, respective filters may be applied to both the difference of the flow rates and the discrete time derivative of the pressure.

The flow rate qᵢₙ of the fluid may be measured at the point of entry of the fluid into the annulus (e.g. at a bottom hole assembly), and the flow rate qₒᵤₜ of the fluid may be measured at the topside end of the annulus, the hydraulic compliance being the hydraulic compliance of the annulus. For example, U.S. Pat. No. 8,196,678 discloses a method of downlinking to a downhole tool that allows measurements made downhole (such as flow rate through a drill bit) to be sent to topside. Measuring the flow rate qᵢₙ of the fluid at the point of entry of the fluid into the annulus may help reduce high frequency effects and allows the compressibility of the fluid in the tubing to be ignored. However, the flow rate qᵢₙ of the fluid may be measured at the point of entry of the fluid into the tubing, and the flow rate qₒᵤₜ of the fluid may be measured at the topside end of the annulus, the hydraulic compliance then being the hydraulic compliance of the combination of the tubing and the annulus.

The time interval Δt may in some aspects be the time interval between pressure measurements.

The cutoff frequency of the filter which may be applied to the difference of the flow rates may be less than the reciprocal of the acoustic travel time around the wellbore. For example, the filter may have a cutoff frequency which is less than the reciprocal of two or three times the acoustic travel time around the wellbore. Similarly the filter which may be applied to the discrete time derivative of the pressure may have a cutoff frequency which is less than the reciprocal of one, two or three times the acoustic travel time around the wellbore.

In some embodiments, the or each filter may be an auto-regressive moving-average filter. For example, the or each filter may be a moving average filter or may be a one-pole filter. When filters are applied to both the difference of the flow rates and the discrete time derivative of the pressure, the two filters may be the same or different.

The operation to pump fluid onto the flow path can be managed pressure drilling, but may be another operation such as cementing, stimulation, fracturing, a coiled tubing operation, milling etc.

### BRIEF DESCRIPTION OF THE DRAWINGS

Embodiments of the invention will now be described by way of example with reference to the accompanying drawings in which:

FIG. 1 shows a schematic view of a wellbore in which wellbore compliance may be determined in accordance with some embodiments of the present invention;

FIG. 2 shows recorded data for a test well of (a) flow into and flow out of a wellbore, and (b) choke pressure;

FIG. 3 shows further recorded data for the test well of (a) flow into and flow out of the wellbore, and (b) choke pressure; and

FIG. 4 shows a plot of change in volume (ΔV) against change in pressure (ΔP).

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements without departing from the scope of the invention.

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

As disclosed herein, the term “computer readable medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

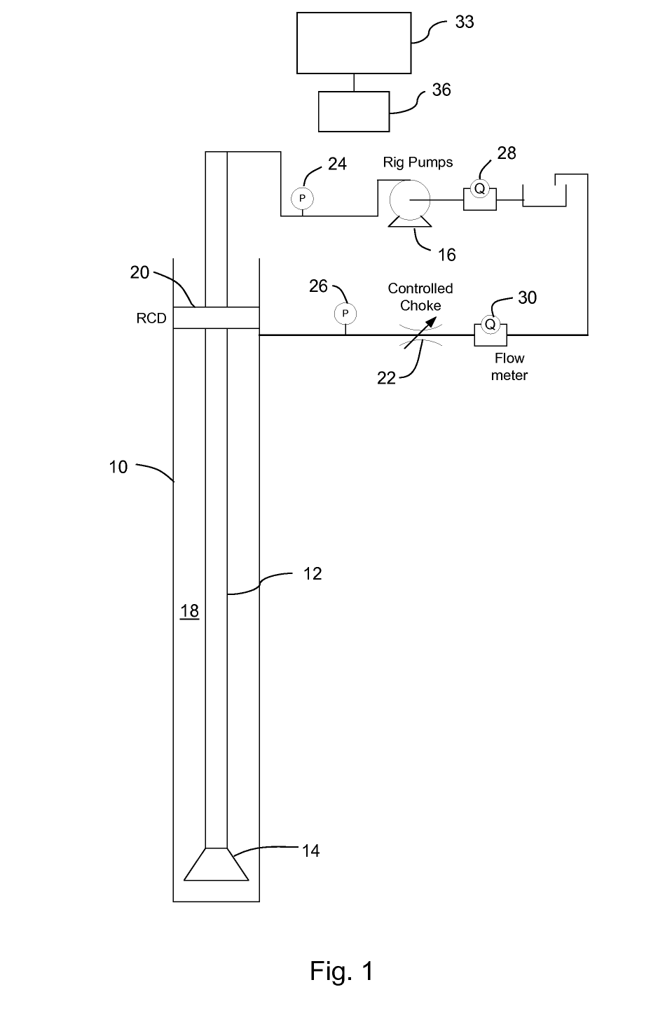

FIG. 1 shows a schematic view of a wellbore 10 containing tubing in the form of a drillstring 12 which ends at bottom hole in a drill bit 14. Drilling fluid is pumped into the drillstring at topside by rig pumps 16. The fluid then flows on a path through the drillstring, exiting at the drill bit and returning to topside through annulus 18 surrounding the drillstring. A rotating control device 20 allows the drillstring to rotate while forming a seal across the top of the annulus. Fluid flow out of the annulus is controlled by a choke 22. The pressure into drillstring and the pressure at the choke are measured by respective pressure meters 24, 26. Respective flow meters 28, 30 also measure the flow rate of the fluid into the drillstring and the flow rate of the fluid out of the annulus through the choke.

During MPD, the flow of drilling fluid into and out of the wellbore is controlled. In particular, the rig pumps 16 and choke 22 are controlled to control the BHP. However, as previously mentioned, for improved control of MPD it is desirable to be able to calculate or model the BHP or the pressure at other points in the drillstring 12 or annulus 18. Better knowledge of the system hydraulic compliance, k, used in equations (1) to (3) above, can assist with this calculation/modeling.

For example, to correctly manage a MPD operation it is important to know the bottomhole pressure that the MPD system is producing. Improper understanding of the bottomhole pressure can result in fracturing of the formation, in-flow of formation fluids into the wellbore and/or production of large pressure variations/oscillations in the wellbore that may take many hours to dissipate. Hydraulic compliance, as determined in accordance with embodiments of the present invention, is necessary to determine the bottomhole pressure from measurements of the fluid in the wellbore, such in-flow, out flow, stand-pipe pressure and/or the like. Moreover, determination of bottomhole pressure in real-time is necessary for controlling and or automating the MPD system.

A processor 33 may be configured to receive measurements regarding operation of the choke 22, rig pumps 16 and/or the rotating control device 20, as well as properties of the flow in to the wellbore and the flow out of the wellbore out of the wellbore, pressure measurements and/or the like. The processor 33 may be configured to determine wellbore compliance and may control operation of the system using the determined wellbore compliance. A controller 36 may by operated by the processor 33 to control various parts of the system.

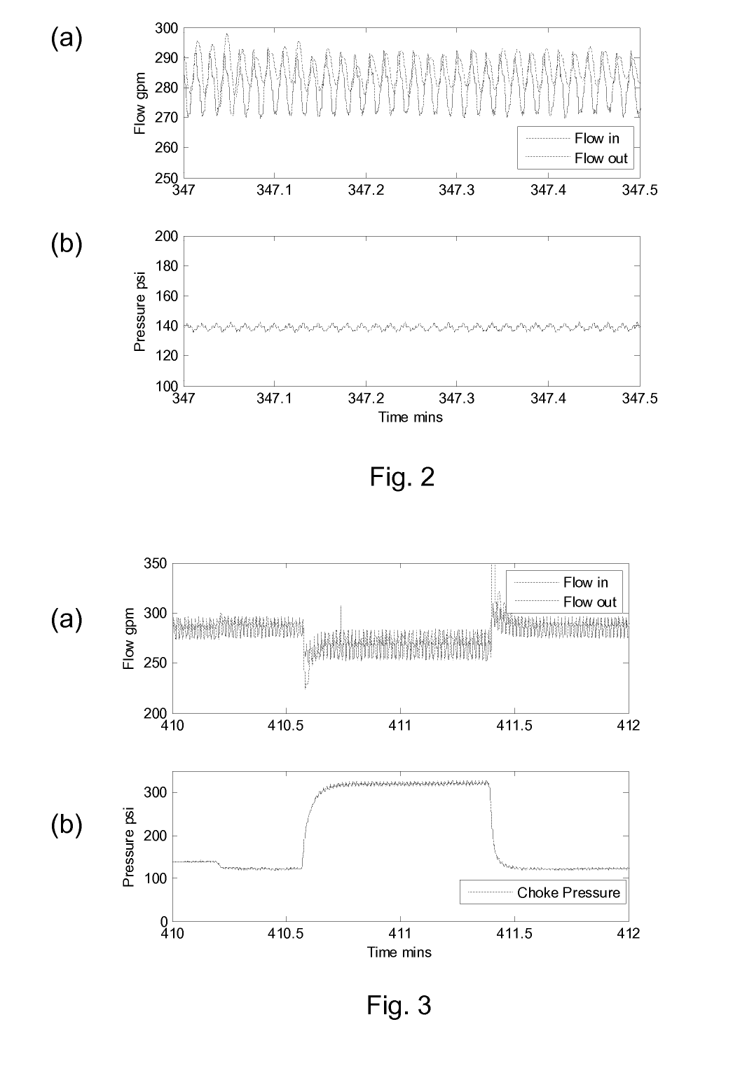

FIG. 2 shows recorded data for a test well of (a) flow in to and flow out of the wellbore, and (b) choke pressure. The fluid used was water based mud, and the pumping was under steady state. The high frequency variation in the data is pump noise. The wellbore extends to a depth of 959 feet (292 meters) inside 9⅝ inch (24.48 cm) casing, with the drill bit being mounted on a 4.5 inch (11.43 cm) drillpipe at a depth of 940 feet (287).

FIG. 3 shows further recorded data for the test well of (a) flow in to and flow out of the wellbore, and (b) choke pressure, but in this case with a step increase and drop of pressure instead of a steady state. Although the differential in the flows looks quite large it is in fact of order 20% of the total flow at its maximum and lasts for less than 5 seconds

Thus, derivation of k is difficult as the change in fluid volume for a 100 psi (689 kPa) change in system pressure is only 0.86 gallons (3.2 litres). In addition, the data show that there is significant signal noise. Also the measurement instruments suffer from different calibrations.

However, processing the data by applying a low pass filter to at least one of the flow rate measurements and the pressure measurement, enables a determination of a hydraulic compliance for the system. In some embodiments, the low pass filter is applied to both of the flow rate measurements.

The finite-impulse response low-pass filtered version of Sₖ can be defined by:

$$F ( {S}_{x} ) = {\sum }_{m = 0}^{m = N} {S}_{t - {m}^{*} Δ t} {W}_{m} \qquad ( 4 )$$

Thus, for a set of weights Wₘ such that the Fourier transform of Wₘ contains predominantly low frequencies, and applying to equation (1) re-cast with the discrete time derivative of the pressure, provides:

$$F ( \frac{{P}_{t} - {P}_{t = Δ t}}{Δ t} ) = \frac{1}{k} F ( {q}_{in} - {q}_{out} ) + C \qquad ( 5 )$$

where t is time, Δt is a time interval which is typically the time interval between pressure measurements, and C is a constant

If the set of weights Wₘ are equal, F is simply a moving average filter. However, instead of a moving average window, an infinite-impulse response filter may be used, such as a one-pole filter, defined by:

F(Sₜ)=(1−δ)F(S_{t-Δt})+δSₜ (6)

I some aspects, the filter may be an auto-regressive moving-average (ARMA) filter:

$$F ( {S}_{t} ) = {\sum }_{m = 0}^{m = A} {a}_{m} F ( {S}_{t - {m}^{*} Δ t} ) + {\sum }_{n = 0}^{n = B} {b}_{m} {S}_{t - {n}^{*} Δ t} \qquad ( 7 )$$

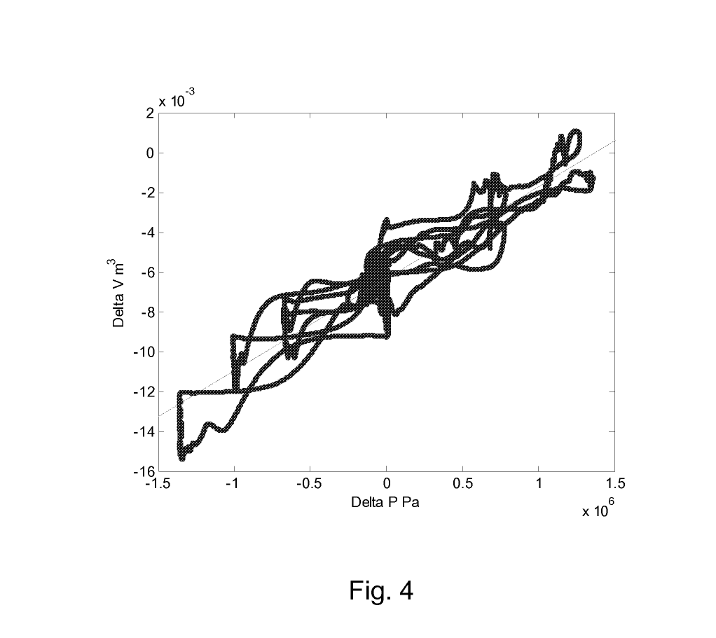

Applying a moving average filter to the flow rate data from the test well with the moving average filter extending over a time span of 20 seconds (corresponding to a cutoff frequency of 0.05 Hz), and applying a low pass filter with a similar cutoff frequency of 0.05 Hz to the choke pressure data provided the plot FIG. 4, which shows change in volume (ΔV=(qᵢₙ−qₒᵤₜ)*Δt) against change in pressure (ΔP).

Applying a linear fit to the plotted data allows k to be derived from the gradient of the fitted straight line, and in this case estimates 1/k as 4.6*10⁻⁹ m³/Pa. Assuming the casing (not shown in FIG. 1) surrounding the annulus 18 is stiff, and dividing 1/k by the volume of the fluid in the system, produces a value for the compressibility of the water based mud drilling fluid which correlates well to a 4.2*10⁻¹⁰ Pa⁻¹ compressibility of water.

Thus despite the challenging measurement environment and a low signal to noise ratio, it is possible, using an embodiment of the present invention, to determine a system hydraulic compliance “on-the-fly”/in real-time and with a useable accuracy.

In some embodiments, the cut-off frequency for the or each low pass filter may be less than the reciprocal of the acoustic travel time around the wellbore, and in some aspects may be less than the reciprocal of two or three times the acoustic travel time around the wellbore. In the test well example, this may be achieved by having the moving average filter extend over a time span of 20 seconds. However, to avoid filtering out gross changes in the system the moving average filter should not extend over more than about 60 seconds.

In the example above, the compliance is determined for the entire drilling string and annulus. However, instead of using the rig pump 16 flow rate, the flow rate through the bit 14 can be calculated using methods such as those described in U.S. Pat. No. 8,196,678, and this calculated rate may be used instead of in the equations. This approach, in accordance with an embodiment of the present invention, may help to remove some of the higher frequency effects that equation (2) ignores, and also may remove the compressibility of the fluid in the drillstring 12 from the compliance determination.

Having determined the compliance, in some embodiments, the compliance may be used to control the pumped flow rate and/or the fluid pressure at the choke, for example in order to achieve a set pressure (e.g. at bottom hole/the bottom of the wellbore) and/or a set fluid extraction rate. For example, the approach for performing MPD described in WO 2011/036144 may be applied, or any other approach for performing MPD known to the skilled person.

Another use of the approach for determining compliance discussed above is in abnormal behaviour detectors. For example, changes to the compliance can be used for kick detection, influx characterization, as well as evaluation of ballooning and wellbore compliance. Changes to the constant term, C, can be used to detect influx or efflux, and changes in flow meter characteristics. In some embodiments, the determined compliance may be used in an automated/semi-automated MPD system, where the MPD system may be controlled by a processor to maintain a desired bottomhole pressure. Sensors may be used to determine properties of the wellbore and/or the MPD system and the processor may determine a compliance, in some aspects in real-time, from which operation of the MPD system may be controlled. A display (not shown) may be used to display compliance to a driller who may oversee operation and/or control the MPD system.

While the invention has been described in conjunction with the exemplary embodiments described above, many equivalent modifications and variations will be apparent to those skilled in the art when given this disclosure. For example, although described above in relation to MPD, the invention may also be applied to other operations, such as cementing, stimulation, fracturing, a coiled tubing operation, milling. Accordingly, the exemplary embodiments of the invention set forth above are considered to be illustrative and not limiting. Various changes to the described embodiments may be made without departing from the scope of the invention.

All references referred to above are hereby incorporated by reference for all purposes.

1. A method of determining a hydraulic compliance of a wellbore during an operation to pump fluid into a flow path which extends downhole through tubing located in the wellbore and then returns in an opposite direction through an annulus surrounding the tubing to a topside end of the annulus, the method comprising:
receiving measurements of the pressure P of the fluid at the topside end of the annulus;
receiving measurements of a flow rate qᵢₙ of the fluid into at least a portion of the flow path;
receiving measurements of a flow rate qₒᵤₜ of the fluid out of said portion of the flow path;
determining a difference of the flow rates (qᵢₙ−qₒᵤₜ), wherein the difference of the flow rates comprises difference between the flow rate qᵢₙ and the flow rate qₒᵤₜ;
determining a discrete time derivative of the pressure, wherein the discrete time derivative comprises (Pₜ−P_{t-Δt})/Δt where t is time and Δt is a time interval;
processing the difference of the flow rates and the discrete time derivative of the pressure by applying a low pass filter to at least one of the difference of the flow rates and the discrete time derivative of the pressure; and
determining a hydraulic compliance of the wellbore for said portion of the flow path as a gradient of a straight line fitted to values of the processed difference of the flow rates plotted against values of the processed discrete time derivative of the pressure.

2. A method according to claim 1, wherein respective low pass filters are applied to the difference of the flow rates and the discrete time derivative of the pressure.

3. A method according to claim 1, wherein the flow rate qᵢₙ of the fluid is measured at the point of entry of the fluid into the annulus, and the flow rate qₒᵤₜ of the fluid is measured at the topside end of the annulus, the hydraulic compliance being the hydraulic compliance of the annulus.

4. A method according to claim 1, wherein the flow rate qᵢₙ of the fluid is measured at the point of entry of the fluid into the tubing, and the flow rate qₒᵤₜ of the fluid is measured at the topside end of the annulus, the hydraulic compliance being the hydraulic compliance of the combination of the tubing and the annulus.

5. A method according to claim 1, wherein the time interval Δt is the time interval between pressure measurements.

6. A method according to claim 1, wherein the or each filter has a cutoff frequency which is less than the reciprocal of the acoustic travel time around the wellbore.

7. A method according to claim 1, wherein the or each filter is an auto-regressive moving-average filter.

8. A method according to claim 1, wherein the or each filter is a moving average filter.

9. A method according to claim 1, wherein the or each filter is a one-pole filter.

10. A method of controlling the pumped flow rate and pressure of fluid in a wellbore during an operation to pump the fluid onto a flow path which extends downhole through tubing located in the wellbore and then returns in the opposite direction through an annulus surrounding the tubing to a topside end of the annulus, the pressure of the fluid being controllable at the topside end of the annulus, the method including:
determining a set pressure for the fluid at a position on the flow path;
determining a set extraction rate of the fluid at the topside end of the annulus;
performing the method of claim 1 to determine the hydraulic compliance of the wellbore; and
controlling the pressure of the fluid at the topside end of the annulus and/or controlling the pumped flow rate of the fluid onto the flow path in dependence on the hydraulic compliance to achieve the set pressure and extraction rate.

11. A method according to claim 10, wherein the set pressure is the bottomhole pressure.

12. A method according to claim 10, wherein the pressure of the fluid is controlled at the topside end of the annulus by a seal and choke arrangement.

13. A method of detecting abnormal behaviour of a wellbore during an operation to pump fluid onto a flow path which extends downhole through tubing located in the wellbore and then returns in the opposite direction through an annulus surrounding the tubing to a topside end of the annulus, the method including:
performing the method of claim 1 to determine the hydraulic compliance of the wellbore;
detecting abnormal behaviour on the basis of changes in the hydraulic compliance and/or in the constant term of the fitted straight line.

14. A method according to claim 13, wherein the abnormal behaviour is influx of fluid into the wellbore or efflux of fluid out of the wellbore.

15. A method according to claim 13, wherein the operation is a managed pressure drilling operation.

16-18. (canceled)
